(19) United States
(12) Patent Application Publication
(10) Pub. No.: US 2016/0138512 A1
(43) Pub. Date: May 19, 2016

(54) METHOD FOR PRE-MIXED IGNITION STRENGTH CONTROL USING SWIRL CONTROL AND ENGINE CONTROL SYSTEM THEREBY

(71) Applicant: Hyundai Motor Company, Seoul (KR)

(72) Inventor: Chang-Yeol Choi, Suwon-si (KR)

(73) Assignee: Hyundai Motor Company, Seoul (KR)

(21) Appl. No.: 14/820,030

(22) Filed: Aug. 6, 2015

(30) Foreign Application Priority Data
Nov. 14, 2014 (KR) 10-2014-0158670

(51) Int. Cl. F02D 41/30; F02M 35/10

(52) U.S. Cl. CPC F02D 41/3035; F02M 35/10059

(57) ABSTRACT

An engine control system may includes a meted for performing pre-mixed ignition strength using swirl control, in which when an ECU determines the difference between the initial optimum level and a detected pre-mixed ignition strength due to ignition pressure of cylinders, the opening amount of Swirl Control Valve is controlled by the ECU on the basis of swirls changing turbulent intensity of the air around fuel flowing into the cylinders and a swirl control optimization mode for matching the pre-mixed ignition strength with the initial optimum level through the control of the opening amount of the SCV is implemented, such that combustion keeps with the pre-mixed ignition strength maintained the initial optimum level.

### CROSS-REFERENCE TO RELATED APPLICATIONS

The present application claims priority to Korean Patent Application No. 10-2014-0158670, filed on Nov. 14, 2014, which is incorporated herein by reference in its entirety.

### BACKGROUND OF THE INVENTION

1. Field of the Invention

Embodiments of the present invention relate to a method for pre-mixed ignition strength control determined by a mixing speed of fuel and air, and more particularly, to a method for pre-mixed ignition strength control using swirl control that influences turbulent intensity of air around fuel which determines the mixing speed of fuel and air, and an engine control system.

2. Description of Related Art

In general, accurate and efficient control of fuel injection timing of an injector is necessary for satisfying strict regulations on fuel efficiency and exhaust of internal combustion engines, and for this purpose, in control of an injector, open loop type of fuel injection timing control has been replaced by closed loop type of fuel injection timing control.

For example, the closed loop type of fuel injection timing control for an injector can more efficiently cope with enhancement of regulations on fuel efficiency and exhaust by readjusting the fuel injection timing of an injector in consideration of the RPM of an engine after fuel is injected.

An example of such control has been disclosed, in which a ignition pressure sensor is mounted on each of the cylinders of an engine, the current ignition state is determined by matching the information from the ignition pressure sensors with a pressure curve of the ignition pressure sensors, and the main injection amount and injection timing of an injector are adjusted by adjusting an injection order signal on the basis of the determination, thereby keeping the ignition state optimal.

However, in the prior art document, the main injection timing and the injection amount are calculated from the maximum ignition pressure after the top dead center and then the optimum injection timing and injection amount are determined on the basis of the calculation, so there is a large error in the calculation and the calculation itself is also complicated, and particularly, changes in ignition due to the differences between the cylinders cannot be considered.

Therefore, the control method proposed in the prior art document necessarily has a large possibility of exceeding the level regulated on EM/fuel efficiency.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for pre-mixed ignition strength control using swirl control that maintains pre-mixed fuel strength at an initial optimum level by changing turbulent intensity of air around fuel, which determines the mixing speed of fuel and air using swirls by controlling the amount of opening of an SCV (Swirl Control Valve), when pre-mixed ignition strength estimated from a heat release rate (HRR) determined on the basis of ignition pressure of cylinders exceeds an initial optimum level, and particularly, that independently controls the amount of opening of the SCV for each of the cylinders and that controls the amount of opening of the SCV on the basis of the average maximum heat release rate of the cylinders, if necessary, and an engine control system.

In accordance with an embodiment of the present invention, a method for pre-mixed ignition strength control using swirl control includes a swirl control optimization mode in which when an Engine Control Unit (ECU) determines the difference between an initial optimum level and a detected pre-mixed ignition strength due to ignition pressure of cylinders, the opening amount of an SCV (Swirl Control Valve) is controlled by the ECU on the basis of swirls changing turbulent intensity of air around fuel flowing into the cylinders, and the pre-mixed ignition strength is matched with the initial optimum level by the control of the opening amount of the SCV.

The swirl control optimization mode may include: (A) determining the pre-mixed ignition strength by detecting an HRR (Heat Release Rate) height using the ignition pressure, and defining the detected pre-mixed ignition strength as a detected HRR height; (B) defining an initial optimum level of the pre-mixed ignition strength as a desired HRR height, determining the difference between the desired HRR height and the detected HRR height, and controlling the SCV to produce swirls on the basis of a value for controlling the opening amount of the SCV that is determined from the difference; (C) determining whether the detected HRR height follows the desired HRR height after the control of the opening amount of the SCV, as a condition for an engine RPM (Revolution Per Minute) and an engine load; and (D) when the detected HRR height follows the desired HRR height and the engine RPM is not zero, determining a new detected HRR height from a new ignition pressure and repeating following the desired HRR height.

When the detected HRR height does not sufficiently follow the desired HRR height, (C-1) a new difference from the desired HRR height may be determined using a new detected HRR height, the SCV may be controlled to produce swirls on the basis of a new value for controlling the opening amount of the SCV that is determined on the basis of the new difference, whether the new detected HRR height follows the desired HRR height may be determined as a condition for the engine RPM (Revolution Per Minute) and the engine load, and when the detected HRR height follows the desired HRR height and the engine RPM is not zero, a new HRR height may be determined from a new ignition pressure and following the desired HRR height is repeated.

The HRR height may be determined from a graph showing the relationship between the pre-mixed ignition pressure strength and the HRR. The difference may be determined by subtracting the detected HRR height from the desired HRR. The condition for the engine RPM and the engine load may be whether the HRR height, the injection amount of an injector, and an injection timing of the injector are matched after the opening amount of the SCV is controlled.

In accordance with another embodiment of the present invention, an engine control system using pre-mixed ignition strength control using swirl control includes: an ECU that has input data of RPM of an engine by operation of an accelerator pedal, a signal showing a fuel injection amount by an injector, and a signal from an ignition pressure sensor on a cylinder, and determines a difference on the basis of an ignition pressure provided by the ignition pressure sensor on a map showing the relationship between pre-mixed ignition pressure strength and HRR (Heat Release Rate), when there is the difference between a detected pre-mixed ignition strength and an initial optimum level; and an SCV (Swirl Control Valve) that is mounted on the cylinder and of which the opening amount is controlled in response to a PWM (Pulse Width Modulation) DUTY signal applied in accordance with the difference by the ECU to produce swirls changing turbulent intensity of air around fuel flowing into the cylinder.

According to the present invention, swirls influencing turbulent intensity of air around fuel is changed and the mixing speed of fuel and air depending on the turbulent intensity by the change of the swirls is maintained at an initial optimum level of pre-mixed ignition strength, so the pre-mixed ignition strength is implemented by a change of the swirls.

Further, since the change of swirls is based on the pre-mixed ignition strength estimated from a heat release rate determined on the basis of the ignition pressure of each cylinder, there are provided optimum ignition conditions in accordance with the atmospheric temperature, atmospheric pressure, cooling water, and oil temperature, so it is possible to remove the defect of the existing control types that it is difficult to set the optimum conditions.

Further, since the change of swirls is achieved by controlling the opening amount of the SCV on each cylinder, it is possible to consider an ignition change due to the difference between the cylinders.

Further, since the opening amount of the SCV changing the swirls is independently controlled for each cylinder and also controlled on the basis of the average maximum HRR (Heat Release Rate) of each cylinder, the control type for maintaining the initial optimum level of the pre-mixed ignition strength can be achieved in various ways.

Further, since the change of swirls is implemented by controlling the opening amount of the SCV on each cylinder, it is possible to remove the defect that there is a large calculation error on adjustment of the optimum injection timing and the injection amount and the calculation itself is complicated, and particularly, it is possible to achieve a simple engine system for maintaining the initial optimum level of the pre-mixed ignition strength.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating a pre-mixed ignition strength control using swirl control according to an exemplary embodiment of the present invention.

FIG. 2 is a diagram showing the configuration of an engine control system to which the pre-mixed ignition strength control of the present invention is applied.

FIGS. 3A and 3B are a graph showing the relationship between a heat release rate and a pre-mixed ignition strength required for pre-mixed ignition strength control using swirl control according to an exemplary embodiment of the present invention.

FIG. 4 is an exemplary graph of ignition pressure-HRR in which a heat release rate is matched in a pre-mixed ignition area due to the pre-mixed ignition strength control using swirl control according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DESCRIPTION OF SPECIFIC EMBODIMENTS

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

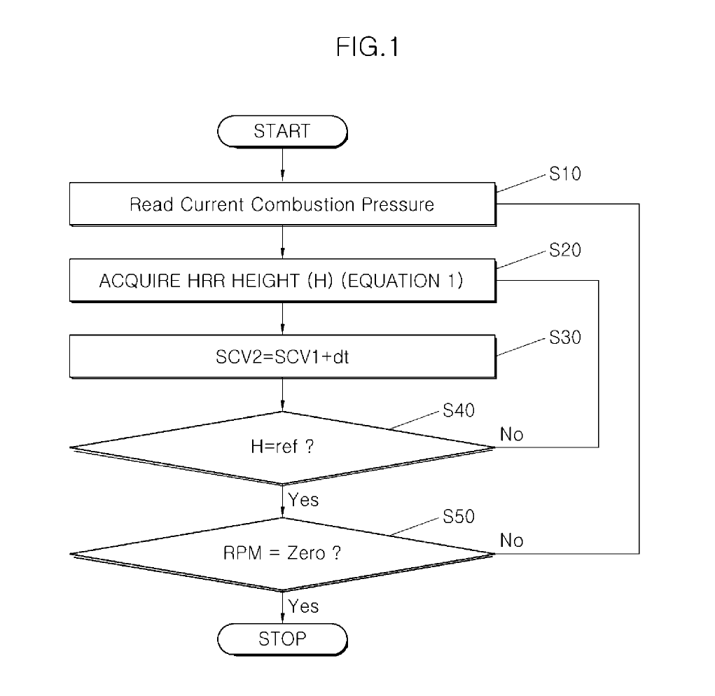

FIG. 1 is a flowchart illustrating a pre-mixed ignition strength control using swirl control according to an exemplary embodiment of the present invention. As shown in the figure, the pre-mixed ignition strength control using swirl control, which is achieved in a closed loop type using an SCV, can easily maintain pre-mixed ignition strength at the initial optimum level by changing turbulent intensity of air around fuel which determines the mixing speed of fuel and air, using swirls obtained by controlling the opening amount of an SCV. In particular, it is possible to control the opening amount independently for each cylinder and also control it on the basis of the average maximum HRR (Heat Release Rate) of cylinders, if necessary. Hereinafter, the pre-mixed ignition strength control using swirl control is referred to as a swirl control optimization mode.

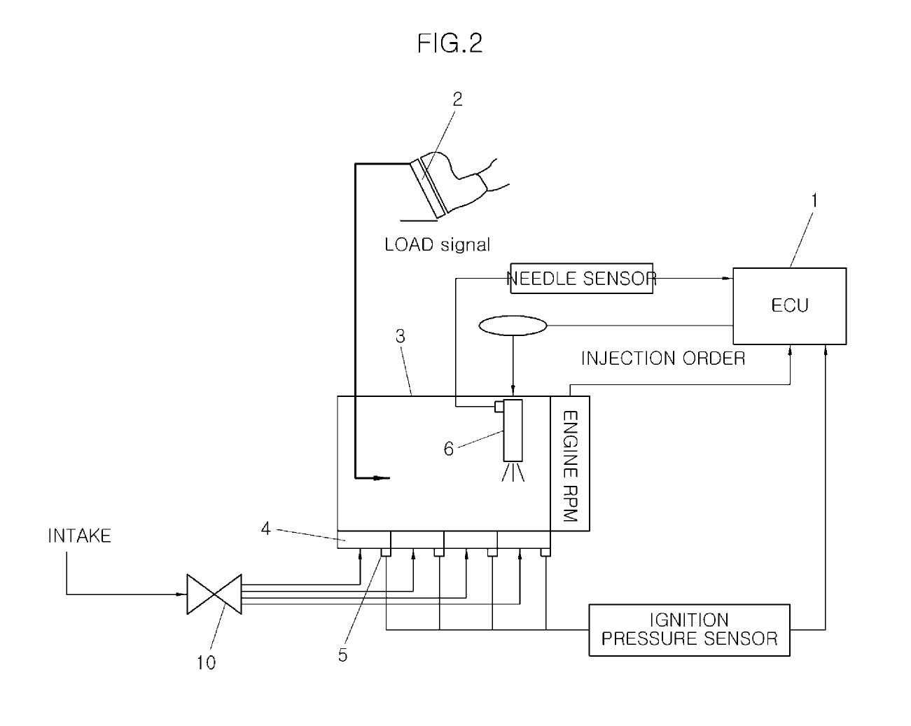

FIG. 2 is an exemplary configuration of an engine control system having the swirl control optimization mode according to an exemplary embodiment of the present invention. As shown in the figure, the engine control system includes SCV 10 mounted on cylinders 4, respectively, of an engine 3 and removes the defect of the existing types, that is, a large error in calculation of optimum injection timing and injection amount, by independently controlling the opening amount of the SCVs 10, and particularly, has a simple configuration for maintaining pre-mixed ignition strength at the initial optimum level.

In detail, the engine control system transmits the RPM of the engine 3 by operation of an accelerator pedal 2, a detection signal showing the fuel injection amount by an injector 6, and a detection signal from ignition pressure sensors 5 on the cylinders 4 to an ECU1. Further, the SCVs 10 on the cylinders 4 change turbulent intensity of air around fuel which determines the mixing speed of fuel and air by producing swirls by the ECU1 controlling their opening amount. In particular, the ECU1 determines whether the pre-mixed ignition strength exceeds the initial optimum level of the cylinders on the basis of pre-mixed ignition strength depending on the HRRs of the cylinders measured by the ignition pressure sensors 5, and independently controls the opening amount of the SCVs 10 on the cylinders 4 on the basis of the determination. Further, the ECU1 may control the opening amount of the SCVs 10 on the basis of the average maximum HRRs of the cylinders 4, if necessary.

The swirl control optimization mode is described hereafter with reference to FIG. 1 again.

The reference numeral ‘S10’ indicates a step of reading ignition pressure of the cylinders 4 detected by the ignition pressure sensors 5. This step starts simultaneously with starting of the engine by igniting, so the ECU1 individually checks the ignition pressure of the cylinders 4.

The reference numeral ‘S20’ indicates a step of sensing HRR height H from ignition pressure detected by the ignition pressure sensors 5. The sensed HRR height H (hereafters, referred to as detected HRR height) may be read out from an HRR map using ignition pressure or directly from the ignition pressure sensors 5. In particular, using the HRR height H is because it is a closed loop control type in which pre-mixed ignition strength control using swirl control is fed back to fit to the optimum level, with the HRR height H set to the optimum level (hereafter, referred to as desired HRR height) as a default.

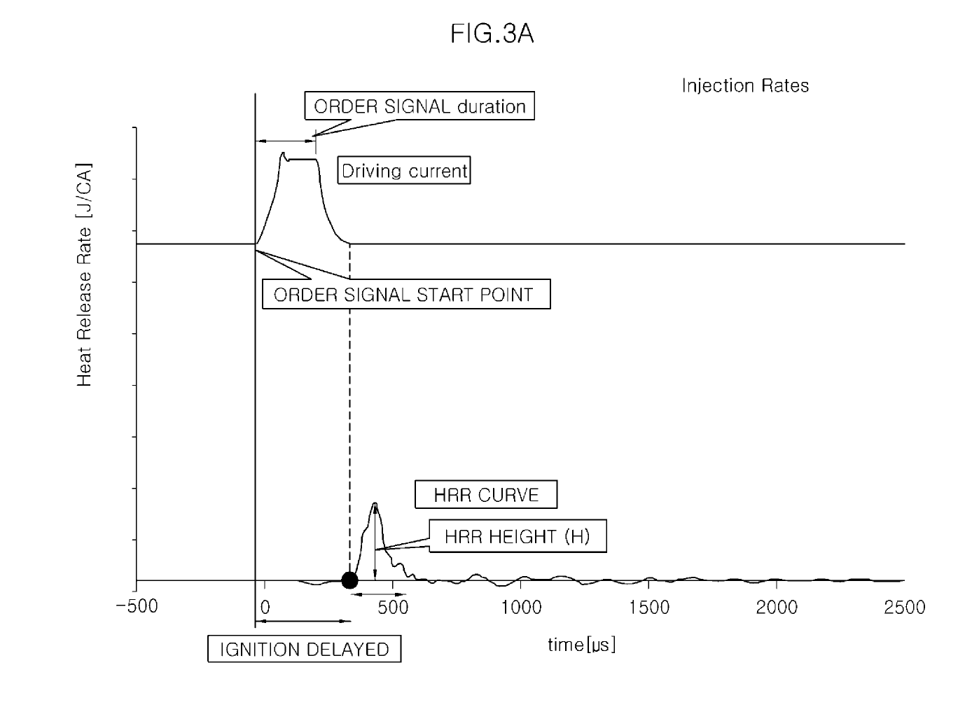

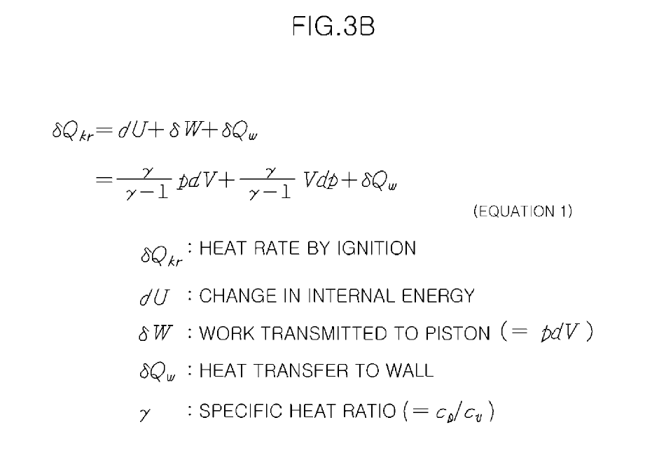

FIGS. 3A and 3B show detecting HRR height H from a graph showing the relationship between the pre-mixed ignition strength and HRR. As shown in the figure, the HRR height H can be known from HRR by ignition and the current injection timing can be known from the HRR start point. The injection amount can also be known from an equation that is proportioned to the HRR height H and the HRR base and inversely proportioned to the amount of heat. Therefore, the HRR height H is detected from HRR by ignition and the HRR is expressed as the following Equation 1.

$$\begin{matrix}δ {Q}_{hr} = dU + δ W + δ {Q}_{w} \\ = \frac{γ}{γ - 1} pdV + \frac{1}{γ - 1} Vdp + δ {Q}_{w}\end{matrix} \qquad ( Equation 1 )$$

δQhₕᵣ: heat rate by ignition

dU: Change in internal energy

δW: Work transmitted to piston (=pdV)

δQ_{w}: Heat transfer to wall

γ: Specific heat ratio (=cₚ/cᵥ)

The reference numeral ‘S30’ indicates a step in which the ECU1 determines whether to control the opening amount of the SCV 10 on the basis of the detected HRR height and controls the opening amount of the SCV 10. To this end, the opening amount of the SCV is calculated from the following Equation 2.

Opening amount of SCV=desired HRR height−detected HRR height (Equation 2)

From Equation 2, the opening amount of the SCV may be a positive value (hereafter, referred to as positive (+) opening amount of SCV) when the desired HRR height is larger than the detected HRR height or a negative value (hereafter, referred to as a negative (−) opening amount of SCV) when the desired HRR height is smaller than the detected HRR height. As for the positive (+) opening amount of SCV, the turbulent intensity of air around fuel which determines the mixing speed of fuel and air is weakened than the opening amount of the SCV is increased, by changing swirls by increasing the opening amount of the SCV by a predetermined amount. In contrast, as for the negative (−) opening amount of SCV, the turbulent intensity of air around fuel which determines the mixing speed of fuel and air is made strengthened than the opening amount of the SCV is decreased, by changing swirls by decreasing the opening amount of the SCV by a predetermined amount. In this embodiment, the effects by the positive (+) opening amount of the SCV and the negative (−) opening amount of the SCV may be opposite to each other, so “+” or “−” has only a simple symbolic meaning.

In this case, turbulent kinetic energy is kinetic energy of variable components of the flow speed of fluid, so turbulent intensity by swirls can be obtained from the following Equation.

The kinetic energy (k) of variable components of the flow speed of fluid is calculated from: k=u′²/2, u(t)=U+u′ (Equation 3)

where u is a flow speed, U is an average speed, u′ is a changing speed (turbulent intensity), and t is time.

Therefore, the control state of the opening amount of the SCV is expressed as SCV2=SCV1+dt, where dt1 is a control value for the opening amount of the SCV, SCV1 is the state before the opening amount is controlled, and SCV2 is the state after the opening amount is controlled. Accordingly, SCV2=SCV1+dt can be expressed as SCVn=SCVn-1+dt, as the number of controlling the opening amount increases.

The change in opening amount of the SCV is made by applying a PWM (Pulse Width Modulation) DUTY signal to the SCV 10 from the ECU1.

The reference numeral ‘S40’ indicates a step of determining whether the pre-mixed ignition strength is suitable for the current state of the engine 3 (hereafter, desired engine state H) after the ECU1 controls the opening amount of the SCV. To this end, the desired engine state H is defined as a reference (ref) for the engine RPM and the engine load, the HRR height H, the injection amount of the injector 6, the injection timing of the injector 6, the current RPM of the engine, and the engine load are detected, and whether the HRR height H, the injection amount, and the injection timing are matched with the reference is determined.

When the desired engine state H is not matched with the reference (ref) in the step S40, the process returns to the step S20, so the HRR height H is sensed again and the opening amount of the SCV is controlled, as in the step S30, thereby controlling the desired engine state H to the reference (ref).

On the contrary, when the desired engine state H is matched with the reference (ref) in the step S40, the process enters the step S50 and whether the engine 3 has been stopped is determined. For this purpose, the ECU1 detects the engine RPM and determines whether the engine has been stopped, from the following Equation 4.

Stop of engine:engine RPM=0 (zero) (Equation 4)

When the engine RPM is larger than zero in the step S50, it is determined that the vehicle is being driven and the process returns to the Step S10 and repeats the steps S10 to S40.

In contrast, when the engine RPM is zero in the step S50, it is determined that the engine has been stopped and the logic is initialized with stop of the control.

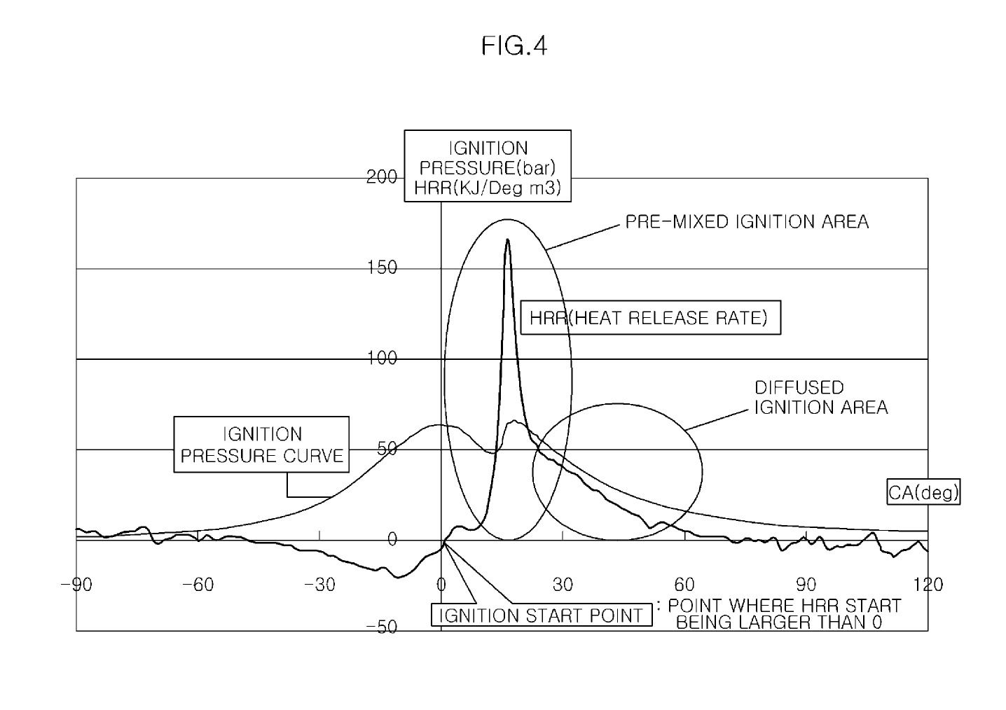

FIG. 4 shows an exemplary ignition pressure-HRR graphs showing the results of the steps S10 to S50, and from which it can be seen that the pre-mixed ignition area is matched with the HRR.

As described above, according to the engine control system performing pre-mixed ignition strength using swirl control of the present invention, when the ECU1 determines the difference between the initial optimum level and a detected pre-mixed ignition strength due to ignition pressure of the cylinders 4, the opening amount of the SCV 10 (Swirl Control Valve) is controlled by the ECU1 on the basis of swirls changing turbulent intensity of the air around fuel flowing into the cylinders 4 and a swirl control optimization mode for matching the pre-mixed ignition strength with the initial optimum level through the control of the opening amount of the SCV is implemented, such that ignition keeps with the pre-mixed ignition strength maintained the initial optimum level. In particular, the opening amount of the SCV is independently controlled for each of the cylinders 4, and if necessary, it is controlled on the basis of the average HRR of the cylinders 4.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for pre-mixed ignition strength control using swirl control, the method comprising:
a swirl control optimization mode in which, when an engine control unit (ECU) determines a difference between an initial optimum level and a detected pre-mixed ignition strength due to ignition pressure of a cylinder, an opening amount of a Swirl Control Valve (SCV) is controlled by the ECU on a basis of swirls changing turbulent intensity of air around fuel flowing into the cylinder, and the pre-mixed ignition strength is matched with the initial optimum level by control of the opening amount of the SCV.

2. The method of claim 1, wherein the ECU controls the opening amount of the SCV by applying a Pulse Width Modulation (PWM) DUTY signal.

3. The method of claim 1, wherein an ignition pressure sensor for detecting the ignition pressure and the SCV are mounted on the cylinder.

4. The method of claim 3, wherein when there is provided a plurality of cylinders, the ignition pressure sensor and the SCV are mounted on the cylinders.

5. The method of claim 1, wherein the swirl control optimization mode includes:
determining the pre-mixed ignition strength by detecting a Heat Release Rate (HRR) height using the ignition pressure, and defining the detected pre-mixed ignition strength as a detected HRR height;
defining an initial optimum level of the pre-mixed ignition strength as a desired HRR height, determining a difference between the desired HRR height and the detected HRR height, and controlling the SCV to produce swirls on the basis of a value for controlling the opening amount of the SCV that is determined from the difference;
determining whether the detected HRR height follows the desired HRR height after control of the opening amount of the SCV, as a condition for an engine Revolution Per Minute (RPM) and an engine load; and
when the detected HRR height follows the desired HRR height and the engine RPM is not zero, determining a new detected HRR height from a new ignition pressure and repeating following the desired HRR height.

6. The method of claim 5, wherein the HRR height is determined from a graph showing a relationship between the pre-mixed ignition pressure strength and the HRR.

7. The method of claim 5, wherein the difference is determined by subtracting the detected HRR height from the desired HRR.

8. The method of claim 5, wherein the condition for the engine RPM and the engine load is whether the HRR height, the injection amount of an injector, and an injection timing of the injector are matched after the opening amount of the SCV is controlled.

9. The method of claim 5, wherein:
when the detected HRR height does not sufficiently follow the desired HRR height, determining a new difference from the desired HRR height by using a new detected HRR height, controlling the SCV to produce swirls on a basis of a new value for controlling the opening amount of the SCV that is determined on a basis of the new difference, and determining whether the new detected HRR height follows the desired HRR height, as a condition for the engine RPM (Revolution Per Minute) and the engine load, and
when the detected HRR height follows the desired HRR height and the engine RPM is not zero, determining a new HRR height from a new ignition pressure and following the desired HRR height is repeated.

10. The method of claim 9, wherein the condition for the engine RPM and the engine load is whether the HRR height, the injection amount of an injector, and an injection timing of the injector are matched after the opening amount of the SCV is controlled.

11. An engine control system using pre-mixed ignition strength control using swirl control, the system comprising:
an engine control unit (ECU) that has input data of RPM of an engine by operation of an accelerator pedal, a signal showing a fuel injection amount by an injector, and a signal from an ignition pressure sensor on a cylinder, and determines a difference on a basis of an ignition pressure provided by the ignition pressure sensor on a map showing a relationship between pre-mixed ignition pressure strength and Heat Release Rate (HRR), when there is the difference between a detected pre-mixed ignition strength and an initial optimum level; and
a Swirl Control Valve (SCV) that is mounted on the cylinder and of which the opening amount is controlled in response to a Pulse Width Modulation (PWM) DUTY signal applied in accordance with the difference by the ECU to produce swirls changing turbulent intensity of air around fuel flowing into the cylinder.

12. The system of claim 11, wherein the SCV and the ignition pressure sensor are mounted on the cylinder.
